(19) United States
(12) Patent Application Publication
(10) Pub. No.: US 2018/0268505 A1
(43) Pub. Date: Sep. 20, 2018

(54) Method of Performing Analysis-Based Conflict Mediation

(71) Applicant: Next Level Mediation, Fort Lauderdale, FL (US)

(72) Inventors: Robert Lawrence Bergman, Scottsdale, AZ (US); Jonathan Ewing, Plantation, FL (US); Jason Charles Bergman, Oakland Park, FL (US)

(21) Appl. No.: 15/927,052

(22) Filed: Mar. 20, 2018

Related U.S. Application Data
(60) Provisional application No. 62/473,573, filed on Mar. 20, 2017.

(51) Int. Cl. G06Q 50/18; G06Q 10/10; G06Q 10/06

(52) U.S. Cl. CPC G06Q 50/182; G06Q 10/067; G06Q 10/10

(57) ABSTRACT

A method of performing analysis-based conflict mediation is performed by executing computer-executable instructions stored on a non-transitory computer-readable medium. The method provides an analytic hierarchy process (AHP), that is stored on a computing device. The method of the present manages a conflict-mediation profile that includes client accounts. Each of which is associated to one of the opposing parties to the mediation process. The method uses mediation criteria, mediation demands, and business objectives and user-supplied importance values as the inputs for the AHP. The AHP generates weights that quantify how emotional and logical the opposing parties are. This analysis is used to rank the parties' desired outcomes and to present the parties with a set of resolutions which are logically based and mutually beneficial.

The current application claims a priority to the U.S. Provisional Patent application Ser. No. 62/473,573 filed on Mar. 20, 2017.

### FIELD OF THE INVENTION

The present invention relates generally to a mediation method. More specifically, the present invention is a method of using an analytical hierarchical process for resolving commercial disputes in mediation.

### BACKGROUND OF THE INVENTION

It is well documented that the cost of litigation in a commercial lawsuit can be very expensive and time consuming. Most participants have a personal stake in the litigation because they feel they have been wronged or wrongfully sued. These personal feelings often result in the desire to punish the opposing party. Each parties desire to punish the opposing party results in a sense of injustice that triggers an equal and opposite reaction from that party. Together, this forms a positive feedback system that reduces the overall willingness to settle the dispute. Although understandable, these feelings and reactions detract from making a reasoned business decision, resulting in a Pareto inefficient negotiation. By applying an analytical hierarchical process to prioritize business goals and deprioritize demands that are purely driven by emotion, the process will result in better outcomes for both parties.

The current mediation process does not treat mediation as a system and therefore does not focus on mitigating the emotional anger that initially accompanies the start of the process. Mediators tend to play on the fears of the participants in order to achieve a settlement, rather than focusing on their true business objectives. The present invention allows mediators to determine the level of emotional anger and true business objectives of each participant in order to shorten the mediation process and deliver outcomes that are Pareto efficient.

The present invention encourages disputing parties to focus on real business priorities and deemphasize emotionally driven demands. The present invention is a combination of face to face discussions with a trained mediator and the application of an analytical hierarchical process (AHP) decision support software system. Each client is required to elicit judgement in two surveys that determine their level of emotional state of mind and their true business priorities. The resulting outcome will take less time to achieve a settlement and will be better aligned with business goals.

Below is a basic example of how the present invention will be used to mediate a conflict between two or more parties, where a first party is a defendant, and a second party is a plaintiff. STEP 1: Agree to terms and conditions of the mediation process and provide all relevant court documents. STEP 2: Determine the level of emotional anger in both parties by having each party evaluate the following four criteria in an AHP tool: 1) Improves my economic recovery, 2) Decreases my cost, 3) Increases the advantage to other party, 4) Punishes the other party. The synthesized weights from this evaluation are used to calculate the Emotional Quotient. STEP 3: Using the AHP tool, both parties are required to evaluate their demands against the emotional quotient criteria. This results in a list of demands that are prioritized by logical thinking. The lowest priority demands will be those prioritized by emotional thinking. STEP 4: Using the AHP tool, the parties are asked to evaluate their business objectives and priorities by judging the following 7 criteria: 1) Competitiveness, 2) Customer relations, 3) Desire to impact the world, 4) level of personal risk, 5) Desire for personal success, 6) Reduced cost of business, 7) Increase in revenue STEP 5: Mediator discusses results of AHP surveys with each client to help align their demands and positions with their business objective priorities. STEP 6: Mediator presents realigned plaintiff demands to defendant for possible agreement and settlement. STEP 7: If defendant agrees to the demands then the mediation ends, and a settlement is reached. If the defendant does not agree to the demands, then the defendant has the option of providing a counter offer to the plaintiff. STEP 8: If the plaintiff accepts the counter offer, then the mediation ends, and a settlement is reached. If the plaintiff does not agree, then the mediator meets with each party and returns to STEP 5.

The present invention is primarily used by mediators who are in the business of resolving commercial disputes. The present invention can be used in both legal and non-legal mediation as well as resolving disputes between groups within enterprises.

### BRIEF DESCRIPTION OF THE DRAWINGS

FIG. 1 is a block diagram illustrating the system overview of the present invention.

FIG. 2A is a flowchart describing a portion of the overall process followed by the method of the present invention.

FIG. 2B is a flowchart describing the remainder of the overall process followed by the method of the present invention.

FIG. 3 is a flowchart describing the sub-process used to assess the emotion-related weight of each mediation criterion for each client account with the method of the present invention.

FIG. 4 is a flowchart describing the sub-process used to assess the emotional quotient for each client account with the method of the present invention.

FIG. 5 is a flowchart describing the sub-process used to assess logic-related weights with the method of the present invention.

FIG. 6 is a flowchart describing a continuation of the sub-process used to assess logic-related weights with the method of the present invention.

FIG. 7 is a flowchart describing the sub-process used to assess business-related weights with the method of the present invention.

FIG. 8 is a flowchart describing the sub-process used to modify the information stored in a client account with the method of the present invention.

FIG. 9 is a flowchart describing the sub-process used for outputting the emotion-related weights with the method of the present invention.

FIG. 10 is a flowchart describing the sub-process used for outputting the emotional quotient with the method of the present invention.

FIG. 11 is a flowchart describing the sub-process used for outputting logic-related weights with the method of the present invention.

FIG. 12 is a flowchart describing the sub-process used for outputting business-related weights with the method of the present invention.

### DETAIL DESCRIPTIONS OF THE INVENTION

All illustrations of the drawings are for the purpose of describing selected versions of the present invention and are not intended to limit the scope of the present invention.

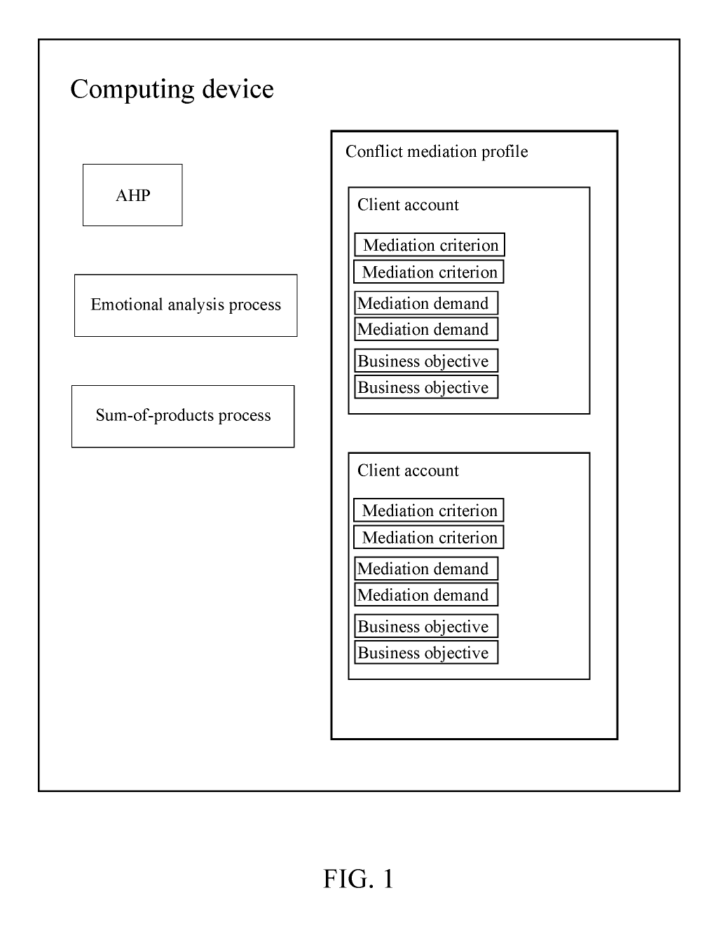

Referring to FIG. 1 through FIG. 12, the present invention, the method of performing analysis-based conflict mediation, is a method that employs an analytic hierarchy process (AHP) to minimize the emotional components that a plurality of opposing parties brings to a mediation process. Because of this, the method of the present invention is able to identify the most logical and mutually beneficial outcomes for the mediation process. Additionally, the method of the present invention enables the opposing parties to perform multiple iterations of the mediation process so as to arrive at an outcome that is agreed upon by all parties. Each iteration of the mediation process generates a measure of the parties' emotional dispositions and then prompts the parties to realign their demands and priorities from more emotional to less emotional. Further, each iteration of the mediation process prompts the parties to assess how any business objectives will be affected by the outcomes of the mediation process. Accordingly, the method of the present invention will provide the opposing parties of the mediation process a means for transforming conflict resolution into a non-zero-sum game. The system required to execute the method of the present invention is a computing device that is capable of executing computer-executable instructions stored on a non-transitory computer-readable medium. The computing device is an electronic system capable of executing the steps of the method of the present invention, outputting information to a user, and receiving input from the user. As such, the computing device can be, but is not limited to being, a personal computer, a smartphone, or a tablet computer. Additionally, the system required to execute the method of the present invention provides an AHP, an emotional analysis process, and a sum-of-products process that are stored on the computing device (Step A). The AHP makes use of a pairwise comparison of the values that each client assigns to a set of mediation process variables. The use of AHP enables the method of the present invention to provide each party with a ranked list of the demands and criteria that, when selected, will provide a logical and beneficial outcome to the mediation process. The emotional analysis process is used to determine the emotional state of the opposing parties. Finally, the sum-of-products process is used to rank the mediation demands for each of the opposing parties from most logical to least logical.

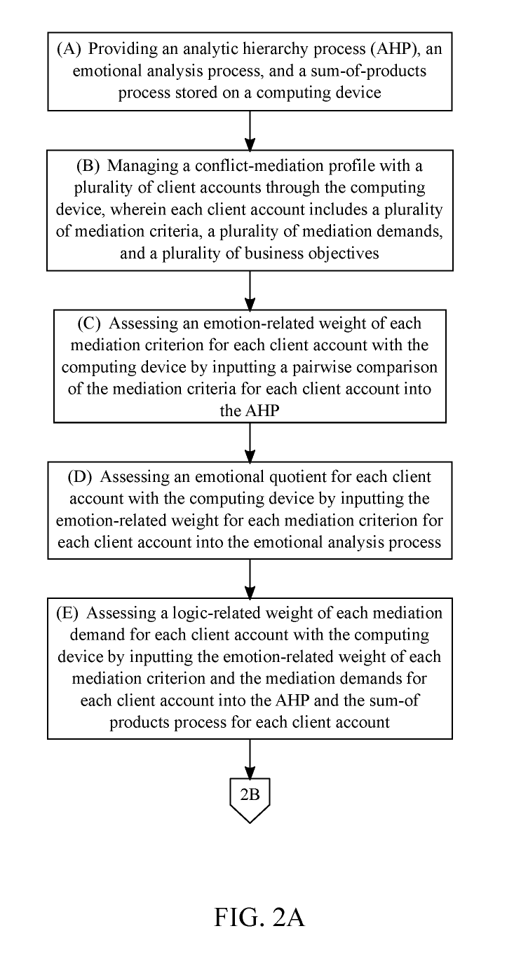

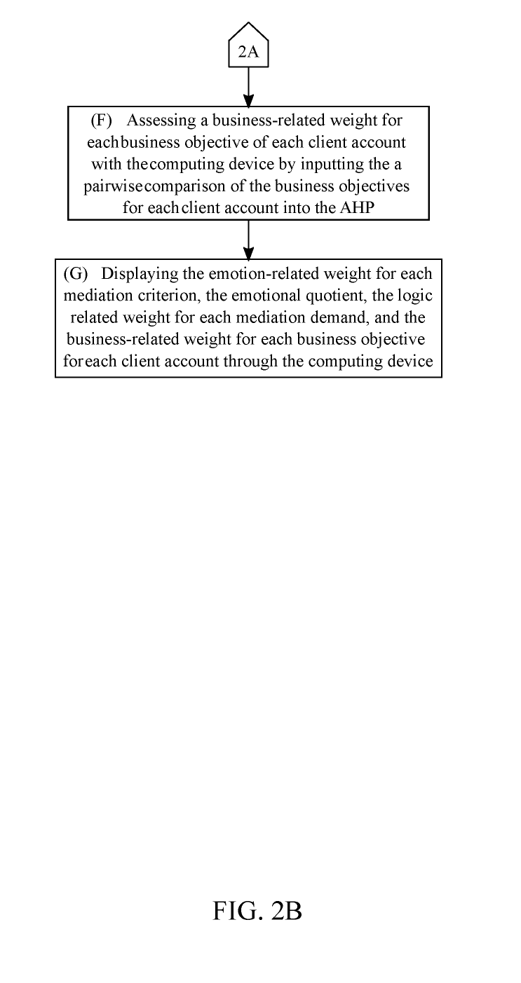

Referring to FIG. 2A the overall method of the present invention is designed to function as a general-purpose routine that can be applied to disparate mediation scenarios. To achieve this, the overall method of the present invention begins by managing a conflict-mediation profile with a plurality of client accounts through the computing device (Step B). The conflict-mediation profile is a record that is used to characterize the type of conflict being resolved and the variables which affect the final resolution. Each of the plurality of client accounts is a record that is dedicated to a corresponding party from the plurality of opposing parties. Additionally, each client account fully characterizes the corresponding party's approach to the mediation process. Specifically, each client account includes a plurality of mediation criteria, a plurality of mediation demands, and a plurality of business objectives. The plurality of mediation criteria includes a set of outcomes that the corresponding party would like to achieve from the mediation process. Specifically, the plurality of mediation criteria contains criterial including, but not limited to, improving economic recovery, minimizing legal fees, minimizing time spent on the mediation process, increasing the cost to the opposing side, and punishing the opposing side. The plurality of mediation demands is a set of demands that the corresponding party would like to have satisfied by the result of the mediation process. The plurality of business objectives is a set of long term objectives that the corresponding party would like to accomplish. Using this information, the method of the present invention is able to generate rankings for the corresponding party's mediation demands and business objectives. The overall method of the present invention continues by assessing an emotion-related weight for each mediation criterion of each client account with the computing device by inputting a pairwise comparison of the mediation criteria for each client account into the AHP (Step C). The emotion-related weight is a value that represents the importance assigned to each mediation criterion by the corresponding party.

Referring to FIG. 2 and FIG. 2B, once the emotion-related weight is identified, the method of the present invention extrapolates the emotional level of the corresponding party. Specifically, the overall method of the present invention continues by assessing an emotional quotient for each client account with the computing device by inputting the individual criteria weight for each mediation criterion and the mediation criteria for each client account into the emotional analysis process (Step D). The emotional analysis process is a sub-process of the method of the present invention that generates a score that represents the corresponding party's emotional vs logical decision-making capabilities. This score is referred to as the emotional quotient. The higher the emotional quotient the more logical the corresponding party. Conversely, the lower the emotional quotient the less logical the corresponding party. The plurality of opposing parties then can be ranked from most logical to least logical, based on each party's the emotional quotient. The overall method of the present invention continues by assessing a logic-related weight of each mediation demand for each client account with the computing device by inputting the emotion-related weight of each mediation criterion and the mediation demands for each client account into the AHP and the sum-of-products process for each client account (Step E). The logic-related weight is a score that quantifies the logical value of each mediation demand with respect to the plurality of mediation criteria. For example, if the corresponding party has demands A, B, and C, the AHP and the sum-of-products process can determine that demand C is more logical than demand A, but demand A is more logical than demand B. Accordingly, the logic-related weight of demand C will be higher than that of demand A. Likewise, demand A will have a higher logic-related weight than demand B. The overall method of the present invention continues by assessing a business-related weight for each business objective of each client account with the computing device by inputting the a pairwise comparison of the business objectives for each client account into the AHP (Step F). The business-related weight is a value that represents the importance assigned to each business outcome by the corresponding party. Accordingly, the method of the present invention uses the business-related weight to rank the business objectives of the opposing parties in terms of importance and logical benefit. The overall method of the present invention continues by displaying the emotion-related weight for each mediation criterion, the emotional quotient, the logic-related weight for each mediation demand, and the business-related weight for each business objective for each client account through the computing device (Step G). Once the present invention has organized and ranked the mediation criteria, the mediation demands, and the business objectives, the opposing parties are provided with summaries and recommendations which will guide the opposing parties toward a mutually beneficial solution.

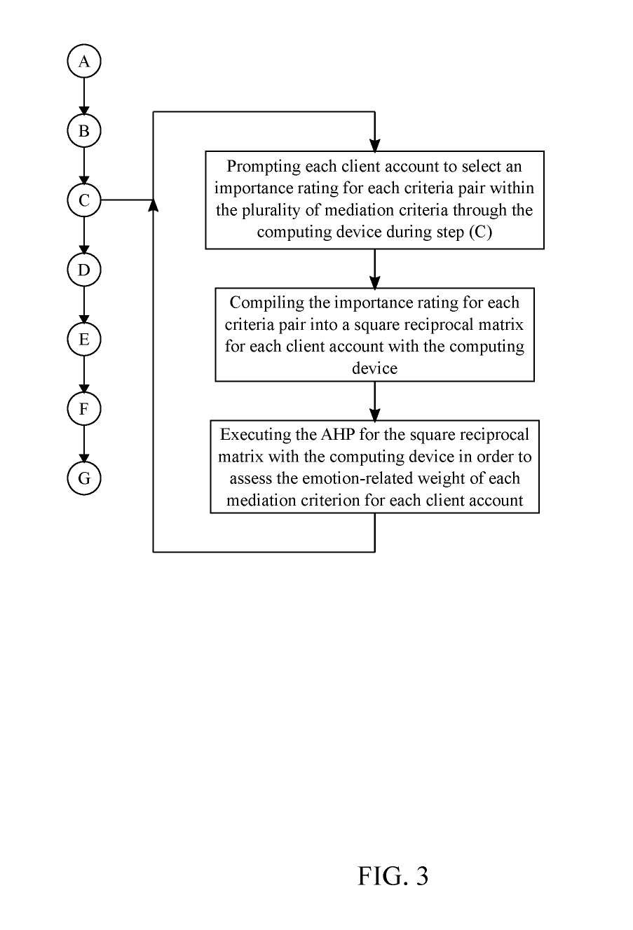

Referring to FIG. 3, the method of the present invention includes a sub-process that is designed to assign a weight which quantifies the importance that the corresponding party places on each mediation criterion included in the client profile. To accomplish this, the sub-process begins by prompting each client account to select an importance rating for each criteria pair within the plurality of mediation criteria through the computing device during Step C. The importance rating is a value that the corresponding party will assign to each mediation criterion in the criteria pair when performing a pairwise comparison of the plurality of mediation criteria. For example, if the plurality of mediation criteria contains a criterion to economically recover and a criterion to punish the opposing party, the corresponding party may rate the criterion to economically recover as being three times more important than the criterion to punish the opposing party. In this pairwise comparison, the corresponding party will assign an importance rating of three to the criterion to economically recover, and an importance rating of one to the criterion to punish the opposing party. The sub-process continues by compiling the importance rating for each criteria pair into a square reciprocal matrix for each client account with the computing device. Accordingly, the importance ratings are arranged into a matrix that is properly formatted to function as an input for the AHP. The sub-process continues by executing the AHP for the square reciprocal matrix with the computing device in order to assess the emotion-related weight of each mediation criterion for each client account. Consequently, the sub-process generates the emotion-related weight which is used to extrapolate the emotional quotient for each of the client accounts.

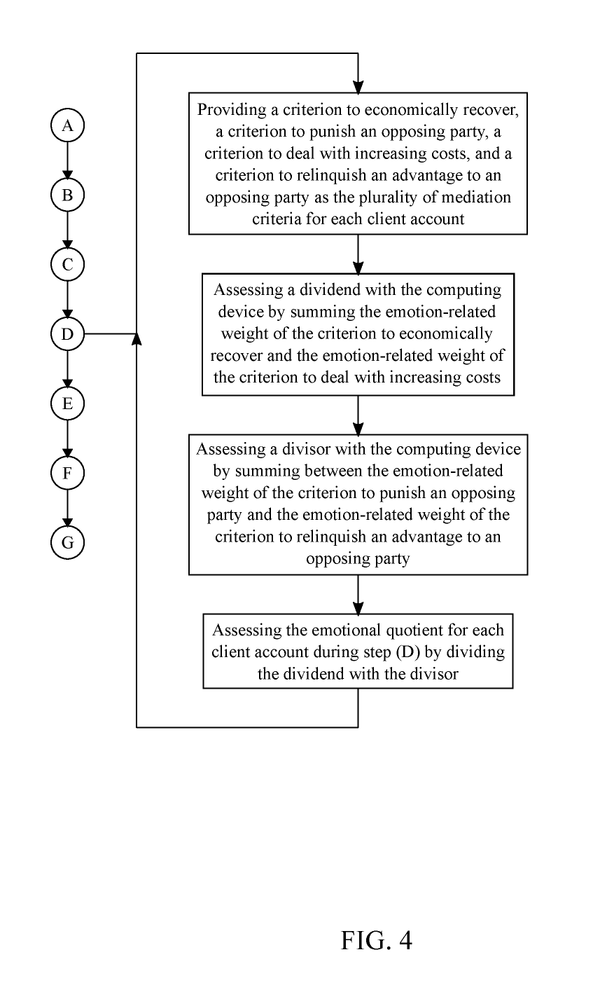

Referring to FIG. 4, the emotional analysis process is a sub-process that is designed to determine the extent to which emotion is a component of each opposing party's decision making. To that end, the sub-process begins by providing a criterion to economically recover, a criterion to punish an opposing party, a criterion to deal with increasing costs, and a criterion to relinquish an advantage to an opposing party as the plurality of mediation criteria for each client account. The sub-process uses the emotion-related weight for each of the mediation criteria during Step C to determine an overall score of each of the opposing parties' emotional state. Specifically, the sub-process continues by assessing a dividend with the computing device by summing the emotion-related weight of the criterion to economically recover and the emotion-related weight of the criterion to deal with increasing costs. The sub-process continues by assessing a divisor with the computing device by summing between the emotion-related weight of the criterion to punish an opposing party and the emotion-related weight of the criterion to relinquish an advantage to an opposing party. The sub-process concludes by assessing the emotional quotient for each client account during Step D by dividing the dividend with the divisor. As a result, the sub-process is able to generate an emotional ranking of the plurality of opposing parties.

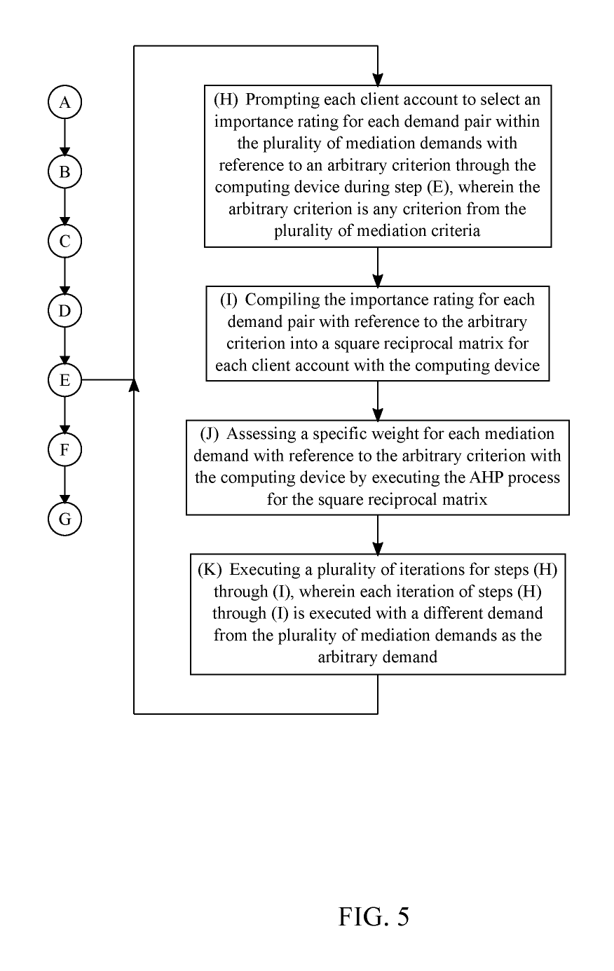

Referring to FIG. 5, the method of the present invention includes a sub-process that assesses the logical benefit of each mediation demand for each of the opposing parties. To achieve this, the sub-process begins by prompting each client account to select an importance rating for each demand pair within the plurality of mediation demands with reference to an arbitrary criterion through the computing device (Step H). This step is used to correlate the pairwise comparison of two mediation demands to an arbitrary criterion that is any criterion from the plurality of mediation criteria. The sub-process continues by compiling the importance rating for each demand pair with reference to the arbitrary criterion into a square reciprocal matrix for each client account with the computing device (Step I). Thus, the sub-process populates a matrix that correlates the importance of each demand pair to the arbitrary criterion. The sub-process continues by assessing a specific weight for each mediation demand with reference to the arbitrary criterion with the computing device by executing the AHP process for the square reciprocal matrix (Step J). The specific weight is a value that represents how highly each mediation demand is prioritized with respect to the arbitrary criterion. The sub-process continues by executing a plurality of iterations for Step H through Step I, where each iteration of Step H through Step I is executed with a different demand from the plurality of mediation demands as the arbitrary demand. Accordingly, for each mediation criterion, there will be a matrix that contains the weights associated with the each of the plurality of mediation demands.

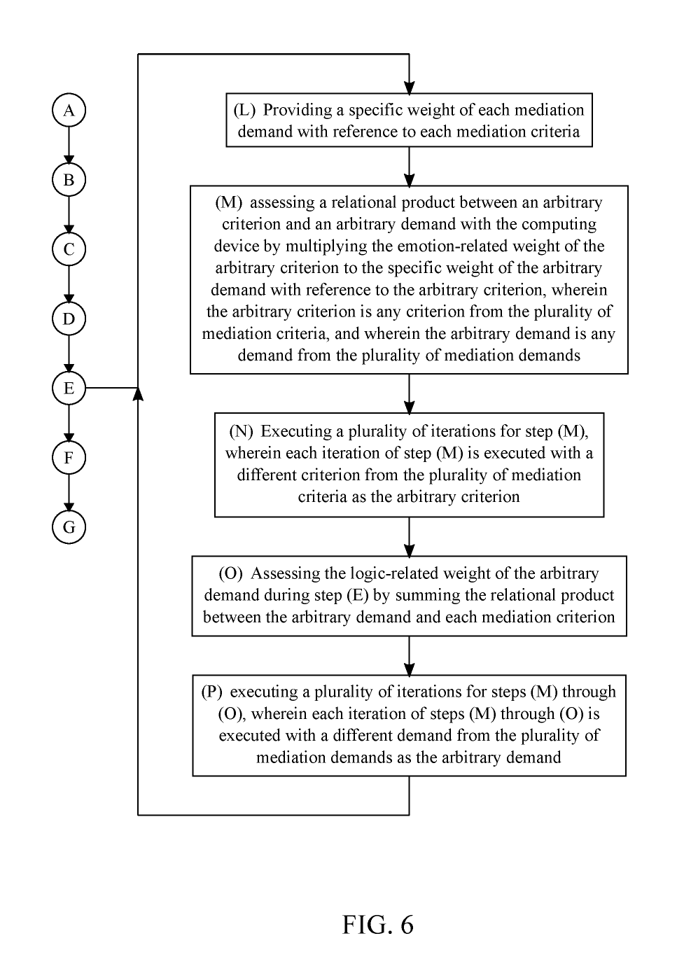

Referring to FIG. 6, the method of the present invention uses the sum-of-product process to calculate the average weights for each mediation demand across the plurality of mediation criteria. To accomplish this, the sub-process begins by providing a specific weight of each mediation demand with reference to each mediation criteria (Step L). The sub-process continues by assessing a relational product between an arbitrary criterion and an arbitrary demand with the computing device by multiplying the emotion-related weight of the arbitrary criterion to the specific weight of the arbitrary demand with reference to the arbitrary criterion (Step M). In this step the arbitrary criterion is any criterion from the plurality of mediation criteria, and the arbitrary demand is any demand from the plurality of mediation demands. Additionally, the relational product is a value that represents a correlation between the emotion-related weight of the arbitrary criterion to the specific weight of the arbitrary demand. The sub-process continues by executing a plurality of iterations for Step M, wherein each iteration of Step M is executed with a different criterion from the plurality of mediation criteria as the arbitrary criterion. Consequently, the sub-process generates a table that contains the relational products for the arbitrary mediation demand relative to the plurality of mediation criteria. The sub-process continues by assessing the logic-related weight of the arbitrary demand during Step E by summing the relational product between the arbitrary demand and each mediation criterion. This enables the sub-process to calculate the logic-related weight for the arbitrary demand by averaging the specific weight of the arbitrary demand across the plurality of mediation criteria. Thus, the true weight of the arbitrary demand can be discovered by considering the arbitrary demand with respect to all of the corresponding party's mediation criteria. The sub-process continues by executing a plurality of iterations for Step M through Step O, where each iteration of Step M through Step O is executed with a different demand from the plurality of mediation demands as the arbitrary demand. Accordingly, the sub-process generates logic-related weights for each of the plurality of mediation demands.

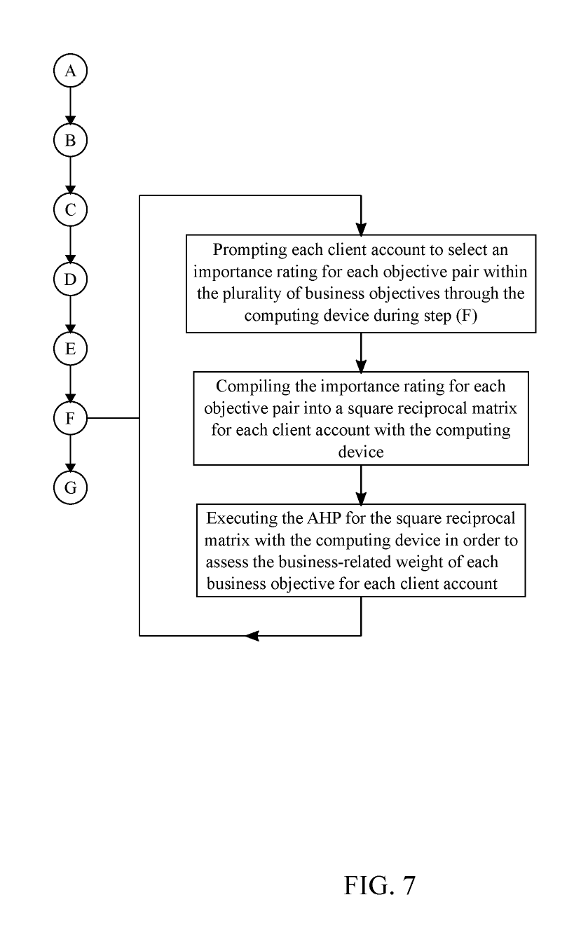

Referring to FIG. 7, the method of the present invention includes a sub-process that is designed to assign a weight that quantifies the importance that the corresponding party places on each business objective included in the client profile. To accomplish this, the sub-process begins by prompting each client account to select an importance rating for each objective pair within the plurality of business objectives through the computing device during Step F. The importance rating is a value that the corresponding party will assign to each business objective in the objective pair when performing a pairwise comparison of the plurality of business objectives. The sub-process continues by compiling the importance rating for each objective pair into a square reciprocal matrix for each client account with the computing device. Accordingly, the importance ratings are arranged into a matrix that is properly formatted to function as an input for the AHP. The sub-process continues by executing the AHP for the square reciprocal matrix with the computing device in order to assess the business-related weight of each business objective for each client account. Consequently, the sub-process generates the business-related weight which is used to extrapolate the importance that each of the client account places on achieving each business objective.

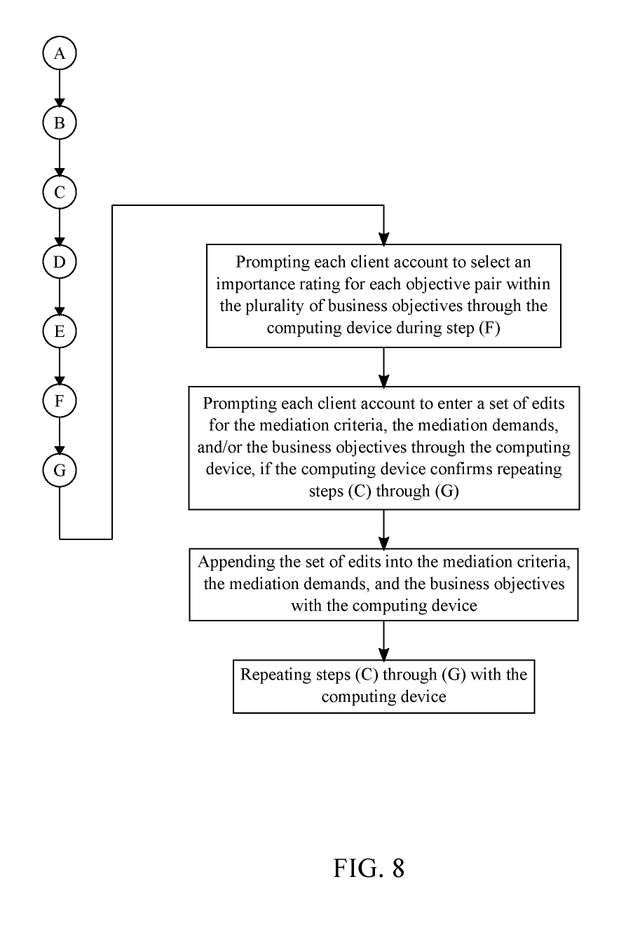

Referring to FIG. 8, because the opposing parties involved in the mediation process may have vastly different demands, the mediation process may need to be repeated before a suitable resolution is achieved. To that end, the present invention includes a sub-process that enables the opposing parties to perform multiple iterations of the mediation process. Each iteration of the mediation process enables the opposing parties to modify the plurality of mediation criteria, the plurality of mediation demands, and the plurality of business objectives included in an associated client account. This sub-process begins by prompting to repeat Step C through Step G with the computing device after Step G. The first iteration of the mediation process presents the opposing parties with reports that describe how the provided mediation criteria, the provided mediation demands, and the provided business objectives are ranked based on emotional analysis and positive outcomes. Further, the first iteration of the mediation process provides recommendations on a resolution that will be beneficial for all parties involved. As described, the opposing parties may be dissatisfied with the recommendations or the information in the reports, that were generated by the first iteration of the mediation process. To receive a different set of recommendations the opposing parties are able to perform subsequent iterations of the mediation process with modified variables. Specifically, the sub-process continues by prompting each client account to enter a set of edits for the mediation criteria, the mediation demands, and the business objectives through the computing device, if the computing device confirms repeating Step C through Step G. The set of edits contains the modifications that the corresponding party will make to the mediation criteria, the mediation demands, and the business objectives. The sub-process continues by appending the set of edits into the mediation criteria, the mediation demands, and the business objectives with the computing device. Accordingly, the set of edits are used to revise the mediation criteria, the mediation demands, and the business objectives that will be used during the next iteration of the mediation process. The sub-process continues by repeating steps (C) through (G) with the computing device. Consequently, the opposing parties will be presented with reports and suggestions that reflect the changes made by the opposing parties. This process can be repeated until the opposing parties arrive at a suitable resolution.

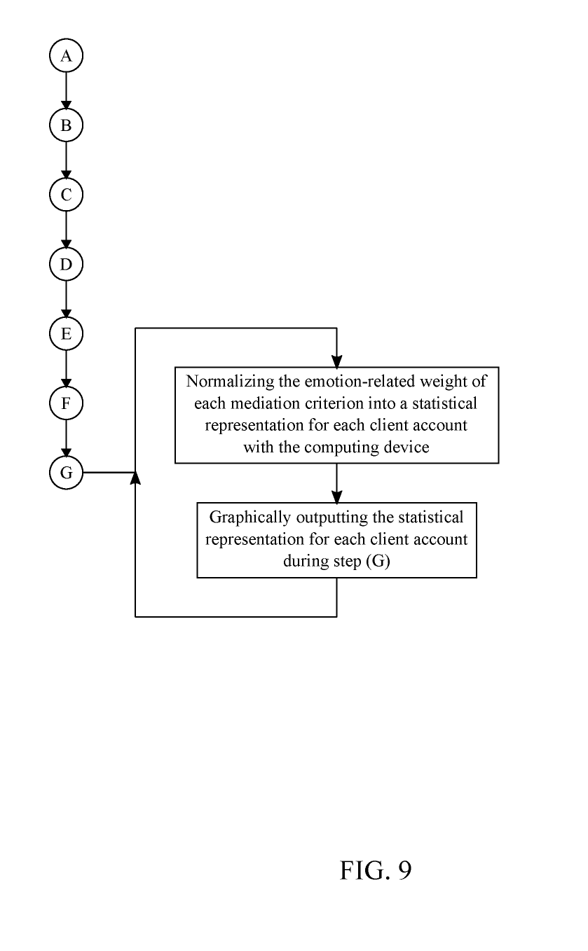

Referring to FIG. 9, the present invention is designed with a sub-process that formats the emotion-related weight that is calculated during the mediation process into a graphical representation of the data. This sub-process begins by normalizing the emotion-related weight of each mediation criterion into a statistical representation for each client account with the computing device. The statistical representation is a transformation that correlates the emotion-related weight of each mediation criterion to a section of a pie chart. The sub-process continues by graphically outputting the statistical representation for each client account during Step G. Specifically, the amount of the pie chart that is associated to each mediation criterion will be proportional to the emotion-related weight of the mediation criterion.

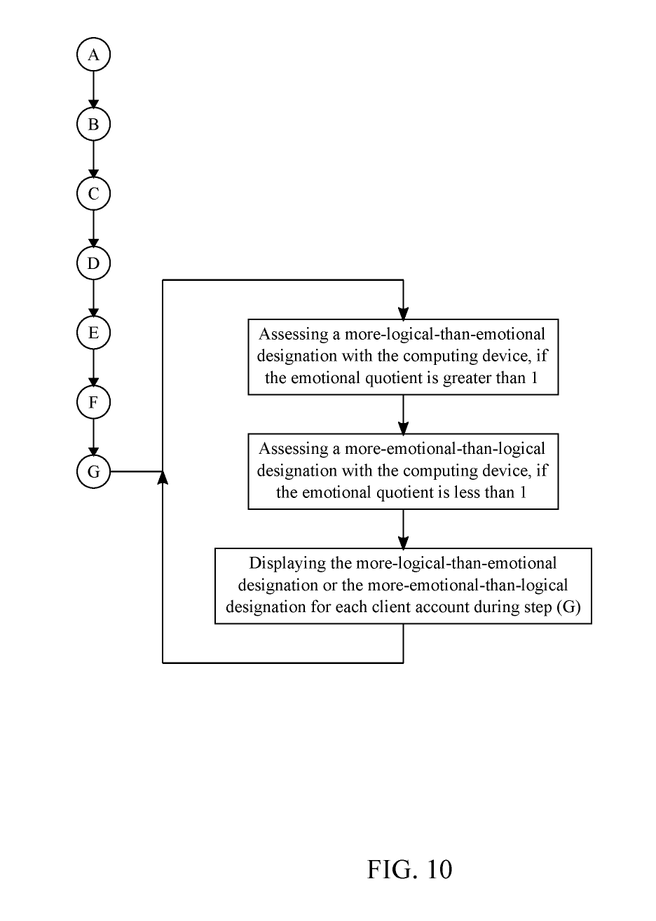

Referring to FIG. 10, the present invention is designed with a sub-process that generates a more-logical-than-emotional designation for the opposing parties. To achieve this, the sub-process begins by assessing a more-logical-than-emotional designation with the computing device, if the emotional quotient is greater than 1. The sub-process continues by assessing a more-emotional-than-logical designation with the computing device, if the emotional quotient is less than 1. The sub-process concludes by displaying the more-logical-than-emotional designation or the more-emotional-than-logical designation for each client account during Step G. Accordingly, the opposing parties are notified of their emotional state. This state may change through multiple iterations of the mediation process as the clients are steered toward achieving logical outcomes.

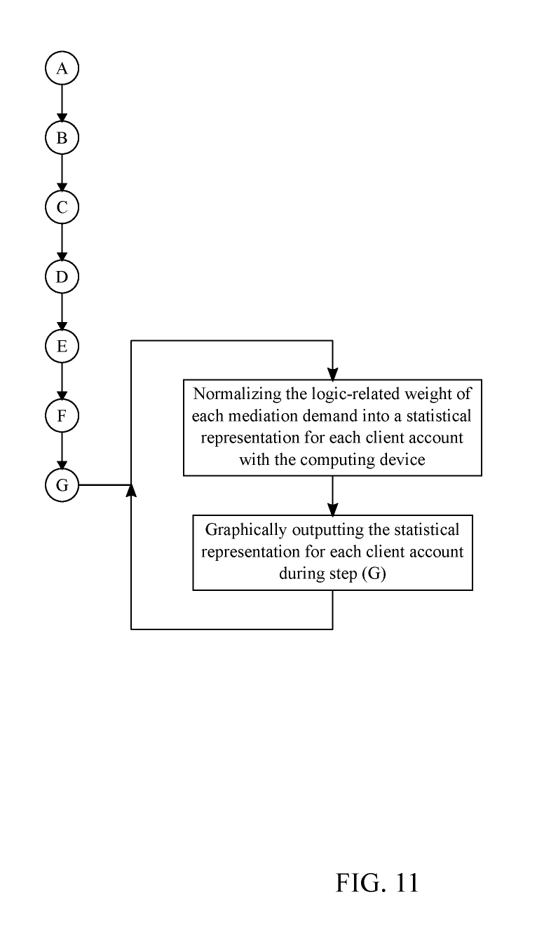

Referring to FIG. 11, the present invention is designed with a sub-process that formats the logic-related weight that is calculated during the mediation process into a graphical representation of the data. This sub-process begins by normalizing the logic-related weight of each mediation demand into a statistical representation for each client account with the computing device. The statistical representation is a transformation that correlates the logic-related weight of each mediation demand to a section of a pie chart. The sub-process continues by graphically outputting the statistical representation for each client account during Step G. Specifically, the amount of the pie chart that is associated to each mediation demand will be proportional to the logic-related weight of the mediation criterion.

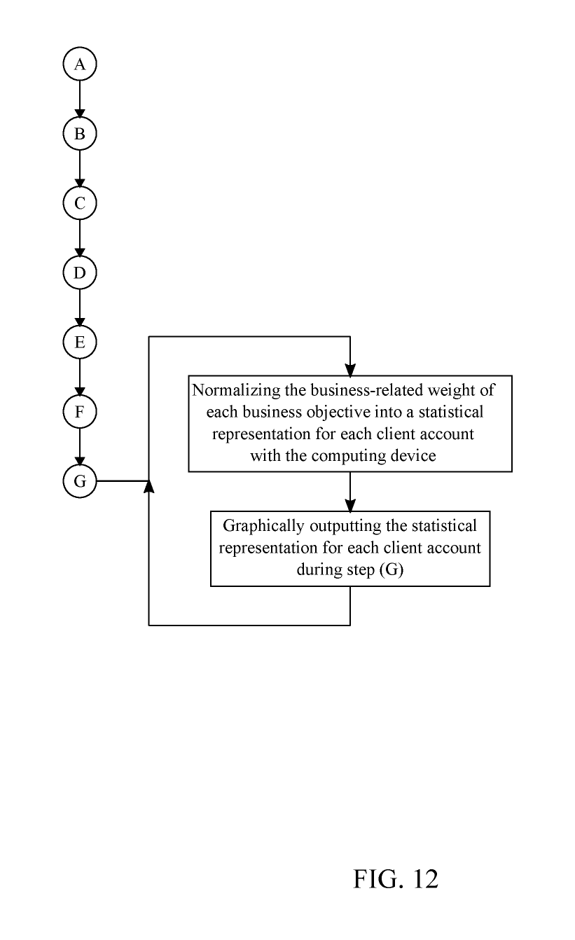

Referring to FIG. 12, the present invention is designed with a sub-process that formats the business-related weight that is calculated during the mediation process into a graphical representation of the data. This sub-process begins by normalizing the business-related weight of each business objective into a statistical representation for each client account with the computing device. The statistical representation is a transformation that correlates the logic-related weight of each mediation demand to a section of a pie chart. The sub-process continues by graphically outputting the statistical representation for each client account during Step G. Specifically, the amount of the pie chart that is associated to each business objective will be proportional to the logic-related weight of the mediation criterion.

Although the invention has been explained in relation to its preferred embodiment, it is to be understood that many other possible modifications and variations can be made without departing from the spirit and scope of the invention as hereinafter claimed.

What is claimed is:

1. A method of performing analysis-based conflict mediation by executing computer-executable instructions stored on a non-transitory computer-readable medium, the method comprises the steps of:
(A) providing an analytic hierarchy process (AHP), an emotional analysis process, and a sum-of-products process stored on a computing device;
(B) managing a conflict-mediation profile with a plurality of client accounts through the computing device, wherein each client account includes a plurality of mediation criteria, a plurality of mediation demands, and a plurality of business objectives;
(C) assessing an emotion-related weight of each mediation criterion for each client account with the computing device by inputting a pairwise comparison of the mediation criteria for each client account into the AHP;
(D) assessing an emotional quotient for each client account with the computing device by inputting the emotion-related weight for each mediation criterion for each client account into the emotional analysis process;
(E) assessing a logic-related weight of each mediation demand for each client account with the computing device by inputting the emotion-related weight of each mediation criterion and the mediation demands for each client account into the AHP and the sum-of-products process for each client account;
(F) assessing a business-related weight for each business objective of each client account with the computing device by inputting the a pairwise comparison of the business objectives for each client account into the AHP;
(G) displaying the emotion-related weight for each mediation criterion, the emotional quotient, the logic-related weight for each mediation demand, and the business-related weight for each business objective for each client account through the computing device;

2. The method of performing analysis-based conflict mediation by executing computer-executable instructions stored on a non-transitory computer-readable medium, the method as claimed in claim 1 comprises the steps of:
prompting each client account to select an importance rating for each criteria pair within the plurality of mediation criteria through the computing device during step (C);
compiling the importance rating for each criteria pair into a square reciprocal matrix for each client account with the computing device;
executing the AHP for the square reciprocal matrix with the computing device in order to assess the emotion-related weight of each mediation criterion for each client account;

3. The method of performing analysis-based conflict mediation by executing computer-executable instructions stored on a non-transitory computer-readable medium, the method as claimed in claim 1 comprises the steps of:
providing a criterion to economically recover, a criterion to punish an opposing party, a criterion to deal with increasing costs, and a criterion to relinquish an advantage to an opposing party as the plurality of mediation criteria for each client account;
assessing a dividend with the computing device by summing the emotion-related weight of the criterion to economically recover and the emotion-related weight of the criterion to deal with increasing costs;
assessing a divisor with the computing device by summing between the emotion-related weight of the criterion to punish an opposing party and the emotion-related weight of the criterion to relinquish an advantage to an opposing party;
assessing the emotional quotient for each client account during step (D) by dividing the dividend with the divisor;

4. The method of performing analysis-based conflict mediation by executing computer-executable instructions stored on a non-transitory computer-readable medium, the method as claimed in claim 1 comprises the steps of:
(H) prompting each client account to select an importance rating for each demand pair within the plurality of mediation demands with reference to an arbitrary criterion through the computing device during step (E), wherein the arbitrary criterion is any criterion from the plurality of mediation criteria;
(I) compiling the importance rating for each demand pair with reference to the arbitrary criterion into a square reciprocal matrix for each client account with the computing device;
(J) assessing a specific weight for each mediation demand with reference to the arbitrary criterion with the computing device by executing the AHP process for the square reciprocal matrix;
(K) executing a plurality of iterations for steps (H) through (I), wherein each iteration of steps (H) through (I) is executed with a different demand from the plurality of mediation demands as the arbitrary demand;

5. The method of performing analysis-based conflict mediation by executing computer-executable instructions stored on a non-transitory computer-readable medium, the method as claimed in claim 1 comprises the steps of:
(L) providing a specific weight of each mediation demand with reference to each mediation criteria;
(M) assessing a relational product between an arbitrary criterion and an arbitrary demand with the computing device by multiplying the emotion-related weight of the arbitrary criterion to the specific weight of the arbitrary demand with reference to the arbitrary criterion, wherein the arbitrary criterion is any criterion from the plurality of mediation criteria, and wherein the arbitrary demand is any demand from the plurality of mediation demands;
(N) executing a plurality of iterations for step (M), wherein each iteration of step (M) is executed with a different criterion from the plurality of mediation criteria as the arbitrary criterion;
(O) assessing the logic-related weight of the arbitrary demand during step (E) by summing the relational product between the arbitrary demand and each mediation criterion;
(P) executing a plurality of iterations for steps (M) through (O), wherein each iteration of steps (M) through (O) is executed with a different demand from the plurality of mediation demands as the arbitrary demand;

6. The method of performing analysis-based conflict mediation by executing computer-executable instructions stored on a non-transitory computer-readable medium, the method as claimed in claim 1 comprises the steps of:
prompting each client account to select an importance rating for each objective pair within the plurality of business objectives through the computing device during step (F);
compiling the importance rating for each objective pair into a square reciprocal matrix for each client account with the computing device;
executing the AHP for the square reciprocal matrix with the computing device in order to assess the business-related weight of each business objective for each client account;

7. The method of performing analysis-based conflict mediation by executing computer-executable instructions stored on a non-transitory computer-readable medium, the method as claimed in claim 1 comprises the steps of:
prompting to repeat steps (C) through (G) with the computing device after step (G);
prompting each client account to enter a set of edits for the mediation criteria, the mediation demands, and the business objectives through the computing device, if the computing device confirms repeating steps (C) through (G);
appending the set of edits into the mediation criteria, the mediation demands, and the business objectives with the computing device;
repeating steps (C) through (G) with the computing device;

8. The method of performing analysis-based conflict mediation by executing computer-executable instructions stored on a non-transitory computer-readable medium, the method as claimed in claim 1 comprises the steps of:
normalizing the emotion-related weight of each mediation criterion into a statistical representation for each client account with the computing device;
graphically outputting the statistical representation for each client account during step (G);

9. The method of performing conflict mediation by executing computer-executable instructions stored on a non-transitory computer-readable medium, the method as claimed in claim 1 comprises the steps of:
assessing a more-logical-than-emotional designation with the computing device, if the emotional quotient is greater than 1;
assessing a more-emotional-than-logical designation with the computing device, if the emotional quotient is less than 1;
displaying the more-logical-than-emotional designation or the more-emotional-than-logical designation for each client account during step (G);

10. The method of performing analysis-based conflict mediation by executing computer-executable instructions stored on a non-transitory computer-readable medium, the method as claimed in claim 1 comprises the steps of:
normalizing the logic-related weight of each mediation demand into a statistical representation for each client account with the computing device;
graphically outputting the statistical representation for each client account during step (G);

11. The method of performing analysis-based conflict mediation by executing computer-executable instructions stored on a non-transitory computer-readable medium, the method as claimed in claim 1 comprises the steps of:
normalizing the business-related weight of each business objective into a statistical representation for each client account with the computing device;
graphically outputting the statistical representation for each client account during step (G);
